(19) United States
(12) Patent Application Publication
(10) Pub. No.: US 2007/0162341 A1
(43) Pub. Date: Jul. 12, 2007

(54) Method and System for Distribution and Use of Coupons

(75) Inventors: Von K. McConnell, Leawood, KS (US); Terry Rayburn, Kansas City, MO (US)

Correspondence Address: SPRINT, 6391 SPRINT PARKWAY, KSOPHT0101-Z2100, OVERLAND PARK, KS, 66251-2100, US

(73) Assignee: SPRINT SPECTRUM L.P., Overland Park, KS (US)

(21) Appl. No.: 11/688,508

(22) Filed: Mar. 20, 2007

Related U.S. Application Data
(62) Division of application No. 09/572,282, filed on May 17, 2000.

(51) Int. Cl. G06Q 30/00

(52) U.S. Cl. 705/14

(57) ABSTRACT

A method and system for coupon distribution and use. A merchant provisions a coupon with a coupon server, and the coupon server delivers the coupon to a consumer's device via SMS, WAP push, e-mail, instant messaging, or in another manner. The consumer then presents the device to a merchant at a point of purchase, to convey the coupon from the consumer's device to the merchant for validation and redemption with respect to a sales transaction between the consumer and the merchant. The coupon can be conveyed from the consumer's device to the merchant in various ways, such as via radio frequency transmission or reading of the coupon from a display of the device.

### REFERENCE TO RELATED APPLICATION

This is a divisional of U.S. patent application Ser. No. 09/572,282, filed on May 17, 2000, the entirety of which is hereby incorporated by reference.

### BACKGROUND OF THE INVENTION

1. Field of the Invention

The present invention relates to telecommunications services and more particularly to a method and system for using historical location information to target automatic coupon distribution to telecommunication service subscribers.

2. Description of Related Art

Retailers and manufacturers often sponsor incentive programs to persuade consumers to buy their products and services. These incentives include discount coupons distributed to consumers, whereby a consumer may redeem the coupon when purchasing an associated product or service.

Traditionally, coupons have been distributed on paper form in mass mailings or newspaper inserts. More recently, the marketing industry has begun to embrace a concept of an electronic coupon or “e-coupon,” which can be distributed online much as coupons have been traditionally distributed via newspapers and mail packs. An example of one such system is described in U.S. Pat. No. 5,761,648 (the '648 patent), which issued on Jun. 2, 1998 and is entitled “Interactive Marketing Network and Process Using Electronic Certificates,” the entirety of which is hereby incorporated by reference.

As described in the '648 patent, electronic coupons can be dispensed by displaying the coupons online to a consumer and allowing the consumer to download the coupons to the consumer's personal computer. A coupon issuer dials up a coupon service and creates a set of coupon instructions. The coupon issuer can issue commands to limit coupon distribution by area or by a customer's household profile. Further, via the coupon service, the coupon issuer can view information about people who have selectively downloaded the issuer's coupons, such as household information that the consumers submit to the system.

Modern telecommunications systems have enabled a great deal of consumer mobility. Consumers may travel throughout local areas or across long distances and yet remain in communication with others via wireless or landline telephones, e-mail, instant messaging, audio and video conferencing, and other facilities. As the present inventors have discovered, it would therefore be useful to tailor coupon distribution to the mobile consumer, by providing a system for targeting coupon distribution based on where a consumer has been (and therefore may be) over time.

### SUMMARY OF THE INVENTION

The present invention relates to a method and apparatus for distribution and management of coupons. According to an exemplary embodiment, the invention uses location history of telecommunication service subscribers over time to determine whether the subscribers should receive a particular coupon. Through interaction with a coupon server, a merchant provisions a coupon to be distributed to target recipients. To identify the target recipients, the merchant preferably defines a location profile and provides the profile to the coupon server. The coupon server then queries a location log to identify subscribers matching the location profile. In turn, the coupon server sends the coupon to the identified subscribers.

In an exemplary arrangement, the location profile is a location history profile, which can effectively be a filter keyed to historical location information, such as length of stay in a particular location, recurrence of visit to a particular location, or the like. By querying the location log, the coupon server may identify subscribers that match that location history profile. Alternatively or additionally, the location profile can be a statistical location projection profile, defining concepts such as likelihood of visiting a particular location or likelihood of staying in a particular location for specified period of time, and so forth. To select target subscribers based on such a profile, the coupon server can query the location log and perform an econometric analysis based on location history information, in order to predict which subscribers match the location projection profile.

Thus, in accordance with a first aspect, an exemplary embodiment of the invention provides a method for targeted distribution of coupons. The method includes provisioning (e.g., selecting, configuring or designing) a coupon and selecting at least one target recipient of the coupon based at least in part on a location history of at least one subscriber. A target recipient could be a subscriber whose location history was tracked, an associated entity (such as the person or entity who owns or controls the subscriber device or who pays the bill for service to the subscriber, for instance), or another entity. The coupon is then distributed to each selected target recipient.

The method may further include tracking a location history of the at least one subscriber, whether an individual subscriber or a group of subscribers (such as all employees of a company or division, for instance). This tracking process can take any of a variety of forms. By way of example, it could involve maintaining a log of information defining how long a subscriber has been in one or more given locations over a period of time and/or defining how many times a subscriber has been in one or more given locations. Each given location could vary from case to case but may, for example, be a particular network, a network address, a geographic address, a geographic position, or a cell and/or sector of a wireless telecommunications network.

Location information can be stored in the log each time the subscriber registers for telecommunications services (e.g., with a home location register, a service control point, a mobile positioning center, an e-mail server, an instant messaging server, a web server, a network access server, a 3G or NGN location server, a mobility server, or in any other fashion.) The location information can be pushed or pulled to the log. As an example, a service control point or home location register can spool location information to the log each time a subscriber obtains service qualification (e.g., on power-up or handoff, or in other instances). As another example, the subscriber itself can provide its own location information for storage in the log.

To provision a coupon, in an exemplary embodiment, a merchant (or other entity who wishes to distribute the coupon) may communicate with a provisioning system. The merchant may select or otherwise provide the provisioning system with some or several coupon parameters that cooperatively define the coupon. The provisioning system may then maintain the coupon parameters for later reference.

In accordance with another aspect, an exemplary embodiment of the invention provides a method of targeted coupon distribution that includes (i) selecting a number of telecommunications service subscribers based on location of the telecommunications service subscribers over time, and (ii) distributing a coupon to each selected telecommunications service subscriber. As indicated above, the location used as a basis to select coupon recipients could take any of a variety of forms.

In accordance with yet another aspect, an exemplary embodiment of the invention provides a method of targeted coupon distribution, including sending a coupon as an industry standard short message service (SMS) message to an SMS-entity (such as an SMS-entity residing on a mobile station, an e-mail client, or the like), or via SMTP, POP 3/4, video server, HTML, JAVA applet, or the like. An SMS message, for instance, would carry as payload a number of parameters defining the coupon. Upon receipt at the SMS-entity, the invention may include conveying one or more of the coupon parameters from the SMS-entity to a merchant, to facilitate redemption of the coupon. The process of conveying the coupon from the SMS-entity to the merchant can involve showing a display of at least one of the coupon parameters to the merchant, for instance.

In accordance with another aspect, an exemplary embodiment of the invention provides a method for targeted coupon distribution, which includes tracking a location history of a subscriber, using the location history as a partial basis to select the subscriber to receive a coupon, and sending the coupon to the subscriber. The process of selecting the subscriber to receive the coupon could involve establishing a location history profile and then determining if the subscriber's location history matches the location history profile.

Tracking the location history of a subscriber can involve recording in a data storage medium indications of location of the subscriber over a period of time. Further, the tracking process can involve recording time information corresponding to each indication of location. The time information may be a timestamp, for instance, indicating the date and time when the subscriber was in the given location.

According to yet another aspect, in an exemplary embodiment, a coupon can be distributed to a subscriber by any of a variety of means. As examples, and without limitation, a coupon can be distributed as an e-mail message, an SMS message, an audio or video clip, an instant message, or an ordinary mail message. The type of recipient may bear on the means by which the message is distributed. And the means by which the message is distributed may in turn bear on the form that the message takes.

According to still another aspect, an exemplary embodiment of the invention provides a coupon server having a processor, a data storage medium (e.g., a memory), and a set of machine language instructions stored in the data storage medium and executable by the processor for performing a variety of functions. The functions may include establishing a set of coupon parameters defining a coupon (e.g., by receiving a selection of some or all of the parameters from a merchant or other entity), establishing a location history profile (e.g., at least in part by receiving location history profile parameters from a merchant), querying a location log to identify at least one subscriber matching the location history profile, and distributing the coupon to the at least one identified subscriber. Further, the coupon server can include machine language instructions executable by the processor for determining, based on some portion of the coupon parameters, whether the coupon has yet been redeemed.

According to still a further aspect, an exemplary embodiment of the invention provides a method of conveying a coupon from a consumer to a merchant for redemption. The method can include conveying over a radio frequency or infrared interface from the consumer to the merchant a number of coupon parameters that define the coupon. For instance, the merchant and consumer may each have a device (such as a Bluetooth-capable device), and the method may involve conveying the coupon parameters over a radio frequency (e.g., CDMA, 802.11, or Software Defined Radio (SDR)) or infrared interface from the consumer's device to the merchant's device. Alternatively, other methods of conveying the coupon from consumer to merchant are also possible. By way of example, the merchant could provide a docking station into which the consumer could insert the consumer's mobile station or other device that bears the coupon, and the coupon may thereby be conveyed via the docking station into the merchant's computer system.

According to still another aspect, an exemplary embodiment of the invention may provide a coupon delivery system. The system can involve sending a coupon to a mobile station, where the coupon defines coupon parameters. The mobile station can display or otherwise present the coupon parameters for viewing by a user. To redeem the coupon, a person can then present the mobile station, with the displayed coupon parameters, to a merchant. The merchant can thereby receive at least a portion of the coupon parameters from the mobile stations and can send those parameters to a coupon server for validation and redemption.

These as well as other aspects and advantages of the present invention will become apparent to those of ordinary skill in the art by reading the following detailed description, with appropriate reference to the accompanying drawings.

### BRIEF DESCRIPTION OF THE DRAWINGS

An exemplary embodiment of the present invention is described herein with reference to the drawings, in which:

FIG. 1 is a block diagram illustrating a coupon distribution system arranged to operate in accordance with an exemplary embodiment of the present invention;

FIG. 2 is a flow chart depicting functional blocks of an exemplary embodiment of the present invention;

FIG. 3 is a block diagram depicting a telecommunications network in which an exemplary embodiment of the present invention can be employed;

FIG. 4 is a block diagram illustrating a coupon server in accordance with an exemplary embodiment of the present invention;

FIG. 5 is a screen display depicting an interface provided by a coupon provisioning system in accordance with an exemplary embodiment of the present invention; and

FIG. 6 is a screen display depicting an interface provided by a location history profile provisioning system in accordance with an exemplary embodiment of the present invention.

### DETAILED DESCRIPTION OF EXEMPLARY EMBODIMENT

1. Overview

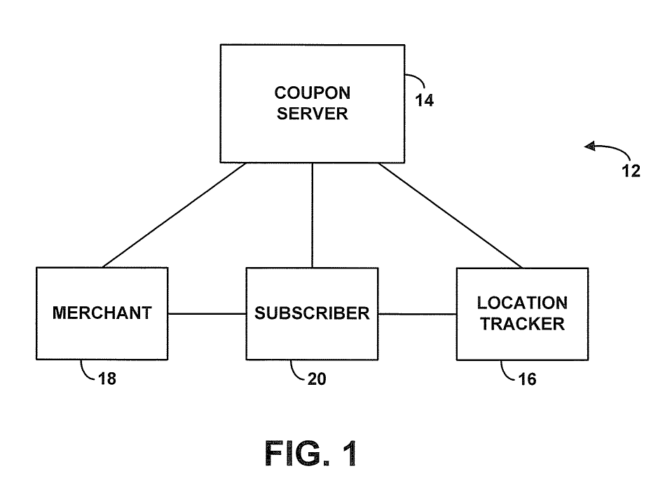

Referring to the drawings, FIG. 1 is a simplified block diagram providing an overview of a coupon distribution system 12 that can operate in accordance with an exemplary embodiment of the present invention. As shown in FIG. 1, system 12 includes a coupon server 14, a location-history tracking system (LHTS) 16, a merchant (coupon-provider) 18, and a subscriber (coupon-recipient) 20.

In an exemplary embodiment, coupon server 14, which may comprise a programmed computer and database, functions as a coupon information repository, a coupon-generation engine, a coupon-distribution engine, and a coupon validation and redemption engine. LHTS 16, which may comprise a database possibly in combination with a programmed computer (e.g., database server), functions to maintain location history of one or more telecommunications subscribers (i.e., people or entities who use telecommunications service, and/or entities used to communicate), such as subscriber 20. Merchant 18, which may comprise a programmed computer, functions to issue coupons to be distributed by server 14 and/or to receive coupons submitted for redemption by a consumer. Merchant 18 can comprise a manufacturer, distributor, retailer, vendor, and/or any other such entity. Subscriber 20, in turn, functions to receive coupons distributed by server 14 and to submit the coupons for redemption.

The various entities shown in FIG. 1 could be coupled together or integrated with each other or with other entities by any suitable interfaces and in any suitable fashion. In an exemplary embodiment, for instance, server 14, LHTS 16 and merchant 18 are each coupled directly or indirectly to the Internet. Merchant 18 might then run a conventional web browser program, and server 14 might run a conventional web server program, thereby allowing a person at merchant 18 to interface with a coupon generation program at server 14 via the World Wide Web. Server 14 may in turn access the database of LHTS 16 via the Internet in order to query LHTS 16 for location history information. Further, LHTS 16 may be coupled directly or indirectly to a telecommunications network in which subscriber 20 operates, in order to enable LHTS 16 to obtain information defining a history of where subscriber 20 has been located. As yet another example, subscriber 20 may be coupled via a network to merchant 18 or may be physically present at merchant 18, in order to present a coupon for redemption.

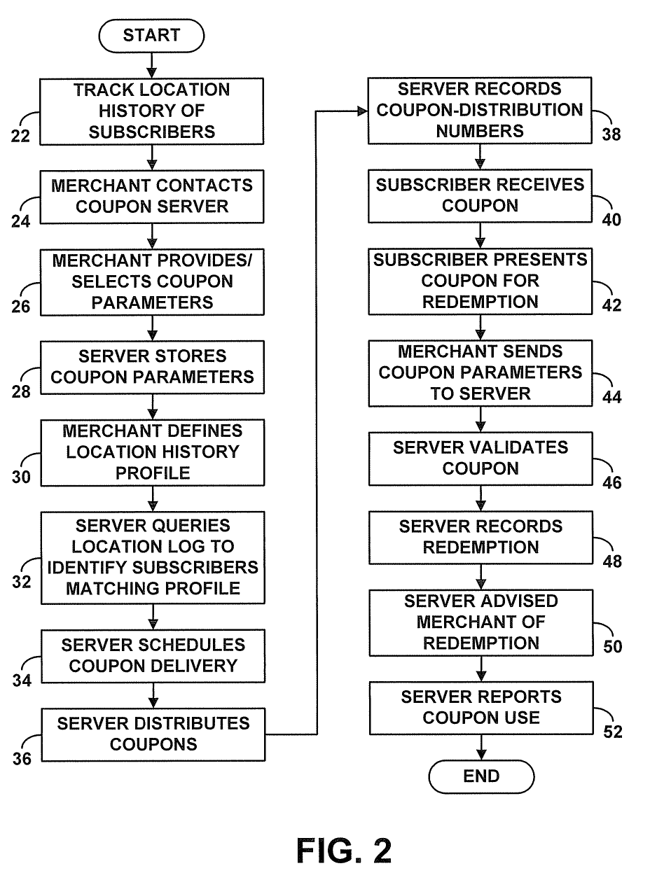

FIG. 2 is a flow chart depicting generally the operation of an exemplary embodiment of the present invention. The order and division of steps in FIG. 2 is not intended to be restrictive.

As shown in FIG. 2, at block 22, LHTS 16 obtains information defining location history of a number of subscribers 20 (i.e., one or more subscribers), individually or by designated groups. For a given subscriber or group of subscribers, this information may include an indication of how long the subscriber (or group) has been in a particular location or area, how many times the subscriber has been in the particular location, or the like. The information may be keyed to location, to subscriber, to group of subscribers, or to any other designator.

At block 24, merchant 18 initiates communication with server 14 in order to provision a coupon to be distributed. At block 26, merchant 18 provides server 14 with parameters that define the coupon. These parameters may include, for instance, (i) a product or service to be promoted by the coupon, (ii) a discount or deal being offered by the coupon in connection with the product or service, (iii) a coupon distribution date and/or desired recurrence of distribution, and (iv) a coupon expiration date. At block 28, server 14 then stores the designated coupon parameters in a database record or other medium for later reference.

At block 30, merchant 18 provides server 14 with parameters to define a location history profile of desired coupon recipients. These parameters may include, for instance, a count of number of times that a potential recipient has been located in a given location, a duration of stay of a potential recipient in a specified location, or other such criteria. At block 32, server 14 then queries LHTS 16 to identify those subscribers that match the defined location history profile. One such subscriber may be subscriber 20 as shown in FIG. 1, for example.

In turn, at block 34, server 14 then schedules delivery of the designated coupon to the identified subscribers. For instance, server 14 may establish a database record for each identified target recipient, indicating for each target recipient (i) an indication of the coupon to be distributed and (ii) an indication of a date for delivery of the coupon. Server 14 may then await the designated distribution date for each coupon or subscriber.

At block 36, at the designated distribution date, server 14 sends the coupon to each identified target recipient. The coupon preferably bears pertinent information, such as indications of (i) the issuing-merchant, (ii) the product or service, (ii) the promotion, (iv) the expiration date, (v) the coupon-identifying number, and (vi) other pertinent terms. Server 14 may deliver the coupon to each target recipient via any of a variety of channels, such as e-mail, short text messaging, instant messaging, video or audio insertion or streaming, conventional postal delivery, or a combination of these or other mechanisms. Further, server 14 may partially or fully outsource the delivery function. At block 38, server 14 preferably records and associates with each distributed coupon a unique identifying number to be used for later validation and redemption.

At block 40, subscriber 20 receives the coupon. In turn, at block 42, the subscriber presents the coupon to a merchant, such as merchant 18 for instance, for redemption. (Just as subscriber 20 could be a subscriber other than that whose location was tracked, merchant 18 could be a merchant other than that who provisioned the coupon.) The method of presentation may depend in part on the means by which the coupon was distributed to the subscriber. For instance, if subscriber 20 comprises an SMS-capable wireless handset, and server 14 distributed the coupon to subscriber 20 via SMS messaging, the subscriber may show the handset display to a person at merchant 18. Alternatively, if the coupon was distributed to the subscriber in a way that allowed the subscriber to obtain a printout of the coupon (e.g., by e-mail), the subscriber may hand the printed coupon to a person at the merchant. As yet another example, if the merchant is an on-line merchant, for instance, the subscriber may present the coupon to the merchant by e-mailing or otherwise transmitting the coupon to the merchant.

At block 44, the merchant seeks to validate and redeem the coupon, by sending to coupon server 14 an identification of the coupon (e.g., the coupon identifying number and/or other coupon terms) and the proposed purchase in connection with which the subscriber wishes to use the coupon. At block 46, server 14 then queries its stored records to ensure that the coupon has not yet been redeemed and to verify that the coupon parameters allow the proposed use of the coupon. At block 48, server 14 then records that the coupon is redeemed. In doing so, server 14 preferably sets a flag in the coupon record indicating that the coupon has been redeemed, so that it cannot be redeemed again, and server 14 may also record information about the context in which the coupon was redeemed. At block 50, server 14 may then advise merchant 18 that the coupon has been validated and redeemed for purposes of the current transaction.

At block 52, the coupon server may periodically (upon request or at designated times) provide merchant 18 with a report of coupons redeemed, to allow the merchant to track coupon use and make decisions about whether and under what circumstances to provision and distribute further coupons.

2. Architecture

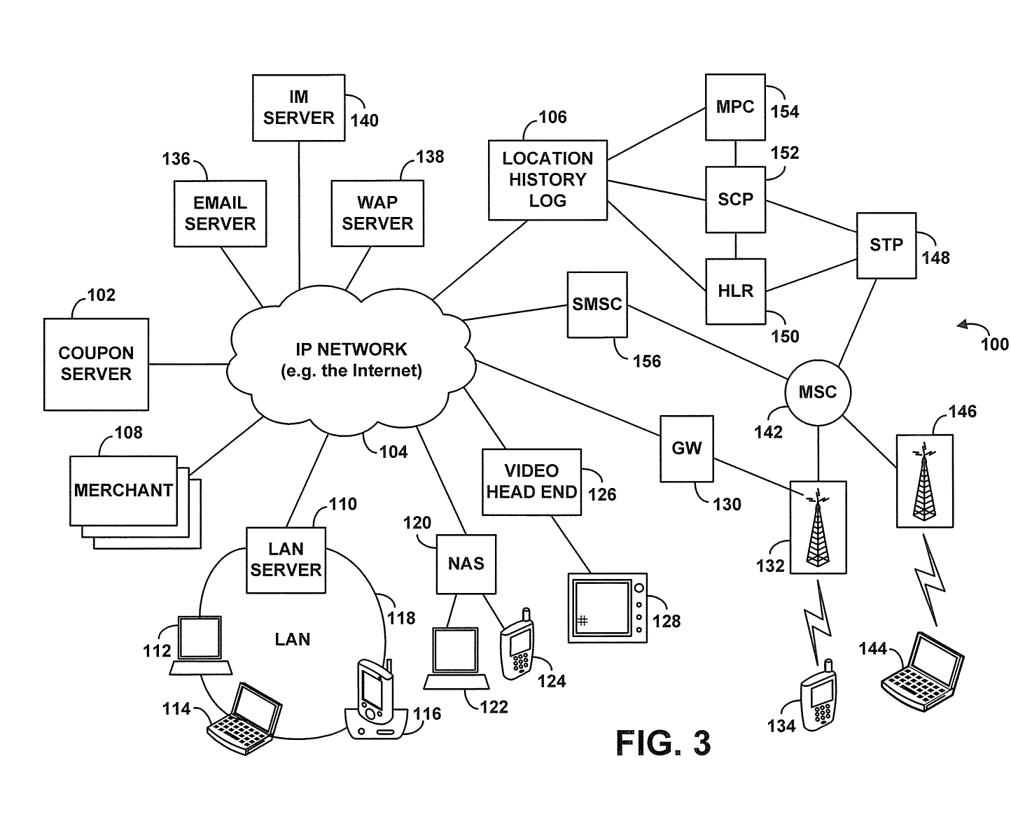

While FIG. 1 depicts a generalized arrangement of entities operating in accordance with an exemplary embodiment of the present invention, various details are possible. For purpose of example, FIG. 3 illustrates in more detail a block diagram of a telecommunications network 100 in which an exemplary embodiment of the present invention can be employed. FIG. 3 depicts a coupon server 102 interconnected to, or part of, a packet switched network 104 (e.g., an ATM or IP network such as the Internet). Via this connection, the coupon server can communicate with a variety of other entities that are also coupled with IP network 104.

As shown in FIG. 3, also connected with IP network 104 are a location history log 106 and a merchant 108, corresponding respectively to LHTS 16 and merchant 18 of FIG. 1. In addition, other nodes on exemplary IP network 104 can include, for instance: (i) a LAN server 110 providing Internet connectivity for a plurality of terminals 112-116 on a local area network 118, (ii) a network access server (also known as “remote access server”) 120 providing Internet connectivity for a plurality of terminals 122-124 such as via a point-to-point connection, (iii) a video/cable head-end 126 for providing video signals to televisions and other devices such as television 128, (iv) a gateway and/or interworking function 130, for providing Internet connectivity via a base transceiver substation (BTS) 132 for devices (mobile stations) in a wireless telecommunications network, such as a personal data assistant (e.g. a Palm computer or the like) or wireless telephone 134, (v) an e-mail server 136, for managing e-mail communications for e-mail clients on the Internet, (vi) a wireless access protocol (WAP) server 138, to serve WAP terminals such as terminal 134 coupled to the Internet, and (vii) an instant messaging (IM) server 140, for providing instant messaging or piped messages between terminals on the Internet. Of course, still other entities may be connected with IP network 104 as well or instead.

As further illustrated in FIG. 3, for purposes of example, network 100 includes a wireless telecommunications network of which an exemplary mobile switching center (MSC) 142 is shown. MSC 142 would normally be associated with a serving system in which mobile stations, such as device 134 and computer 144, can operate. Each mobile station may conventionally operate in a given cell and sector, at the core of which is a BTS, such as BTS 132 or BTS 146. A mobile station communicates with the BTS via a air interface, and the BTS in turn communicates with the MSC, typically via a T1 line.

By convention, MSC 142 is coupled via a signaling network, represented by signal transfer point (STP) 148, to a home location register (HLR) 150 and a service control point (SCP) 152. Both HLR 150 and SCP 152 in the exemplary network are then also shown coupled to the location log 106. In addition, SCP 36 is shown coupled with a mobile positioning center (MPC) 154. Further, MSC 142 is shown conventionally coupled in the wireless telecommunications network to a short message service controller (SMSC) 156, which in turn sits on the Internet. As is known in the art, SMSC 156 serves to store and forward short message service (SMS) messages to or from SMS-capable entities. Examples of such entities might include mobile stations 134, 144, and SMS clients (e.g., e-mail clients) residing on entities such as coupon server 102 or terminals 112-116, 122-124. Other examples are possible as well.

This and other arrangements described herein are shown for purposes of illustration only, and those skilled in the art will appreciate that other arrangements and other elements (e.g., machines, interfaces, functions, etc., whether or not separately known in the prior art) can be used instead, and some elements may be omitted altogether. Further, as in most telecommunications applications, those skilled in the art will appreciate that many of the elements described herein are functional entities that may be implemented as discrete components or in conjunction with other components, in any suitable combination and location.

For instance, although shown as separate entities, HLR 150 and SCP 152 could be integrated into a single entity or distributed as more than two entities. As another example, although location history log 106 is shown as a single entity, it could in fact comprise a number of distributed location tracking entities. As still another example, rather or in addition to having communications via IP network 104, other sorts of communication channels can be provided between the entities of network 100.

Still further, various functions described herein as being performed by one or more entities may be carried out by a processor executing an appropriate set of machine language instructions stored in memory. Provided with the present disclosure, those skilled in the art may readily prepare appropriate computer instructions to perform such functions.

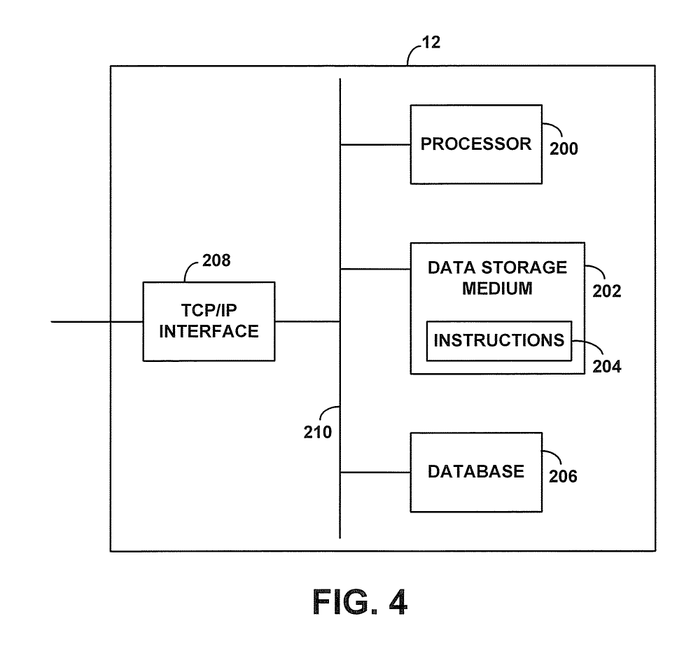

Referring to FIG. 4, exemplary coupon server 102 is shown in greater detail. As shown in FIG. 4, coupon server 102 includes a processor 200, a data storage medium 202, a set of machine language instructions 204 stored in the data storage medium, a database 206, and a TCP/IP interface 208. Each of these components is coupled with a data bus 210, to facilitate communication between components.

In accordance with an exemplary embodiment, the processor 200 is arranged to execute the machine language instructions so as to perform the various functions described herein as being performed by the coupon server. For instance, the machine language instructions preferably define a web server module, a coupon-provisioning module, and a location-log querying module.

Database 206 preferably includes a merchant database for storing information about merchants who issue coupons, a coupon database for storing information about coupons, and a coupon-distribution database for storing information about coupons being distributed to particular target recipients. TCP/IP interface 208 in turn provides a mechanism for the coupon server to communicate with other entities via Internet 104. Of course, coupon server 102 can take other forms as well.

3. Functionality

a. Tracking Location History

In the exemplary embodiment, one or more entities in network 100, alone or cooperatively, can compile and maintain a historical log of where one or more subscribers have been located over time and/or where subscribers are statistically estimated to be in the future. In this regard, “subscriber” can generally refer to a person or entity that uses telecommunications services, whether on a subscription basis or other basis. As an example, a subscriber can be a communication terminal, such as a mobile telephone, a computer, a pager, a personal data assistant, or other device, configured to access or allow access to telecommunications services, whether wired or wireless. As another example, a subscriber can be a person or account-holder who facilitates, uses or otherwise access telecommunications services.

In an exemplary embodiment, for instance, the information maintained in the location history log can be stored in a relational database (e.g., an Oracle database) that includes interrelated tables of (i) subscribers, (ii) communication terminals, (iii) locations, (iv) times, and/or other information. Each of these sets of information can in turn take any of a variety of forms.

The subscriber information may, for example, take the form of individual subscriber names, subscriber-group identifiers, or other subscriber-identifying numbers, names or other codes. The communication terminal information may, for example, take the form of MINs or other terminal-identifiers. The location information may, for example, take the form of geographic (e.g., GPS) positional information (e.g., longitude/latitude information), cell/sector location information, network address information (e.g., TCP/IP address, LAN identifier, network identifier indicating a particular network or networks, etc.), geographic address information (e.g., country, state, county, city, street, intersection, address, floor, or room), facility-description information (e.g., department store, restaurant, etc.), or the like. The time information may, for example, take the form of timestamps indicating when or for how long a given subscriber or communication terminal was present in a given location, or how many times the subscriber or communication terminal was present in the given location (i.e., a recurrence count). Other examples are possible as well.

The method by which location history is tracked, and the type of historical location information logged, will likely depend on the type of subscriber being tracked and/or the medium in which the subscriber travels. For instance, a different mechanism may be applied to track the location of a wireline notebook computer as it is plugged into LAN in New York and a PSTN modem connection in California than to track the location of a wireless telephone as it is moved from a cell in Chicago to a cell in Kansas City.

As an example, a suitable system for tracking location of a mobile station in a wireless telecommunications network is described in U.S. patent application Ser. No. 09/401,933 (the '933 application), entitled “Location and Events Reporting in a Wireless Telecommunications Network,” filed by the owner of the present invention on Sep. 23, 1999. The entirety of the '933 application is hereby incorporated herein by reference. As described in the '933 application, entities in the wireless telecommunications network can spool information about mobile station location to a data collection device, and the location information can then be reported in various forms to other entities, either automatically or on request. The present invention can employ a similar system for tracking location history of a mobile station or other telecommunications device or subscriber. Other arrangements are possible as well.

In an exemplary embodiment, the historical location log of information can be maintained in an entity shown in FIG. 3 as location log 106. Location log 106 can include both a data storage medium and a database server (not shown). The database server provides intelligence to obtain location information, maintain the information in the data storage medium, and convey the information when necessary.

Alternatively, the location log could instead be maintained in another entity (whether or not shown in FIG. 3) or distributed among a combination of entities. For instance, log 106 could instead be maintained in whole or in part as an integral component of coupon server 102 or could be coupled directly or indirectly to coupon server 102 via a connection other than IP network 104.

Information can be pushed and/or pulled to location log 106. For instance, the service logic of HLR 150 or SCP 152 can be arranged to automatically send to (e.g., record in) the location log an indication of the location of a subscriber or mobile station each time the HLR or SCP learns of such location information. Conventionally, for instance, the HLR or SCP may learn the current location of a mobile station each time the mobile station is qualified, such as on power-up, on handoff, at regularly scheduled intervals, or at other times. In each such instance, for example, the HLR or SCP may record subscriber, communication terminal, location and time information in the location log or may send the information to a separate processor, which may, if desired, record the information in the location log. For each subscriber or group of subscribers, a subscriber profile maintained by the HLR or SCP can designate where or when to record location information regarding the subscriber and/or what type of information to record.

Thus, for example, when a subscriber turns on mobile station 134 at a particular time, MSC 142 would conventionally send a registration message (an IS-41 “REGNOT” message) to its HLR 150. The REGNOT message may inform HLR 150 of the cell/sector in which mobile station 134 is currently located. Employing a set of stored logic, HLR 150 may then responsively record in location log 106 an indication that mobile station 134 was located in that cell/sector at that particular time. Had mobile station 134 already been located in that cell/sector, HLR 150 could be programmed to increment a counter or record another indication in the location log, to indicate a duration of the mobile station's presence in that cell/sector or to indicate a number of times that the mobile station has been detected in that location. Similarly, if SCP 152 learns of the location of mobile station 134, SCP 152 may responsively push the location information to the location log.

As another example, a billing or call tracking system (not shown in FIG. 3) may track locations from which calls associated with a particular subscriber or telecommunications device (e.g., telephone, computer, calling-card, etc.) are placed. Conventionally, for instance, validation log messages (VLMs) or call detail record (CDRs) messages or are sent to a back-office system to validate or record completion of a telephone call. These messages typically include information defining the calling subscriber account number (e.g., home telephone number, calling-card number, subscriber name, etc.) and the originating location of the call. The back-office system may be programmed to periodically send this location information to location log 106, so as to maintain in location log 106 records of where calling subscribers have been located over time.

As yet another example, various other entities on IP network 104 may learn of the location of a given subscriber and may programmatically transmit the location information to location log 106. For instance, a subscriber terminal, such as subscriber 112 or subscriber 122, may operate e-mail or instant-messaging (IM) client software for interacting, respectively, with e-mail server 136 or IM server 140. When the subscriber terminal logs into the e-mail server or IM server, the e-mail server or IM server will thereby know the IP address or other network address of the subscriber. In an exemplary embodiment, the e-mail server or IM server may be programmed to record this location information and/or to transmit the information to the location log 106. Alternatively, the location log can query the e-mail server or IM server for this location information.

Similarly, when a subscriber terminal connects to LAN 118 (such as by docking or otherwise plugging into a network connection), LAN server 110 (or other such agent) will learn of the presence of the terminal on the network. LAN server 110 may be programmed to periodically report this location information, in turn, to log 106, or log 106 may be programmed to periodically query the LAN server. In this and other location tracking examples described herein, intermediate, distributed or shared location-tracking entities may be present. For instance, an entity on IP network 104 may be arranged to periodically collect location information from LAN server 110 and network access server 120. The entity may then periodically provide the collected location information to the location log 106.

Still similarly, video head-end 126 may be arranged to know when a particular subscriber is receiving a video signal or cable-modem signal, such as at television 128. As with the above examples, video head-end 126 may then spool this location information to location log 106 or may provide the location information on request.

As still another example, a subscriber itself can be arranged to send location information to the location log, or the location log can be arranged to pull location information from such subscribers. For instance, handset 134 may be arranged with a GPS receiver so as to know its own location with a fair degree of granularity. Handset 134 may then include programmed logic that causes handset 134 to periodically send to the location log an indication of where handset 26 is located at a given time. In the example arrangement shown in FIG. 3, handset 134 could send this location information via a designated signaling channel to BTS 132, to gateway 130, over IP network 104 and in turn to location log 106. Alternative channels to convey this information are possible as well.

As still a further example, in a wireless telecommunications network, MPC 154 or a similar entity can be programmed to periodically (or in response to specified triggering events) determine the location of one or more specified mobile stations. MPC 154 may do so via position determining equipment (PDE), as specified by industry standards for instance. MPC 154 may then provide location log 106 with the location information. Alternatively, or in addition, location log 106 may periodically query the MPC for location histories of one or more mobile stations and the MPC could provide the requested information to the extent available.

The information maintained in location log 14 can be converted from one form to another, upon storing of the information in the location log, upon retrieval of the information from the location log, or at any other desired time. A location server or other entity associated with the location log may initiate or execute these conversions, for instance, by querying or otherwise referring to mapping tables or databases or in any other suitable fashion.

For example, by querying one or more external conversion tables or databases, a location server may convert longitude/latitude geographic information into address information (or geographical information service (GIS) parameters), such as indications of street address or intersection, or to indications of type of facility (e.g., restaurant, gas station, etc.) at the location. The location server may then store the information in the location log for later reference and/or may provide the information to another entity.

As another example, by querying one or more external conversion tables or databases, the location server may convert subscriber terminal-identification information, such as mobile identification number (MIN), serial number, or the like, into an identification of a person, group or company of the subscriber. For instance, if John Smith is the billing contact for a cellular telephone with MIN 123456, and the location log receives an indication that device bearing MIN 123456 was located in Shreveport, La. on a particular day, the location server may query a database that will identify John Smith as the billing contact. The location server may then store an indication of John Smith, preferably with his mailing address or other such information, in the location log, in association with an indication that he was in Shreveport, La. on the particular day.

The information in the location log can be archived periodically. For purposes of targeted coupon distribution, a reasonable period of time to maintain information in the log may be 60 days, for instance. Thus, every day, location information older than 60 days may be programmatically purged and/or archived.

b. Provisioning/Selecting Coupons

In accordance with an exemplary embodiment, merchant 108, can arrange for coupons to be sent to one or more recipients, by communicating with coupon server 102. Preferably, merchant 108 communicates with coupon server 102 in a client-server relationship via the Internet, with merchant 108 running a web client program and server 102 running a web server program. This arrangement will allow a representative of merchant 108 to conveniently interact via a GUI provided at least in part by server 102 from anywhere on the Internet. Alternatively, merchant 108 and server 102 can communicate in other ways, such as via a voice or data connection, over the PSTN or other communications link for instance.

In an exemplary embodiment, a user at merchant 108 will log on via the Internet to a provisioning subsystem of coupon server 102. If merchant 108 has an existing coupon-distribution account, server 102 may prompt the merchant user to log in with a predefined username and password. Alternatively, the provisioning system may allow a new merchant 108 to sign up so as to establish a new coupon-distribution account. In this way, the provisioning system will know the identity of the merchant for purposes of establishing, sending and managing coupons.

The coupon server may store merchant logon information in a cookie on the merchant computer for later reference and use. Further, the coupon server may store merchant-specific information (such as merchant name, merchant coupon-redemption location(s), etc.) in a merchant-database for later reference. Alternatively, such information can be maintained in an external database for later reference.

Via the GUI, or by other means (such as text menus, text commands, file transfer, or voice recognition, for instance), the coupon provisioning system may allow the merchant user to select coupon parameters, possibly by selecting from predefined lists of parameters or coupons and/or by allowing the user to specify custom information. The parameters may include, for instance, (i) products or services to be discounted, (ii) discounts, deals or promotions to be offered, and (iii) timeframes or expiration dates. As used herein, the term “coupon” may be broadly construed to mean a conventional coupon (e.g., a discount voucher) as well as any other promotion, deal, offer, grant, certificate, license, or the like.

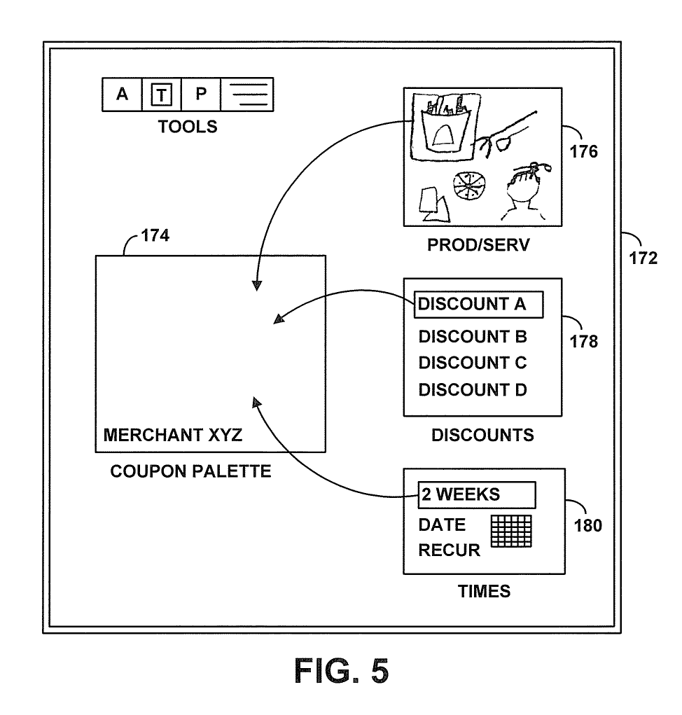

FIG. 5 illustrates an exemplary screen display 172 for a GUI coupon provisioning system. As shown by way of example in FIG. 5, the GUI may present these various options to the user in a “drag and drop” form, allowing the user to click on and drag an image or textual indicator of a particular parameter over to a coupon image or “palette” 174, so as to effectively build the coupon on screen. One such image may be a user-specifiable parameter, such as a text box that, upon dragging to the coupon, the user could fill in with a desired parameter definition. Suitable techniques for generating and employing such graphical interfaces in other contexts (e.g., form design in Microsoft Visual Basic and other graphics-based programming languages) are well known in the art and therefore are not described here in detail.

Alternatively, if merchant 108 has access to the appropriate information (such as product/service lists, available discounts, timeframes, etc.), a similar provisioning system run locally on a terminal of merchant 108 can provide a user with a suitable interface to design the coupon locally. Once the coupon parameters have been selected, the local provisioning system or another mechanism could then forward the coupon parameters to coupon server 102.

As shown in FIG. 5, for example, the provisioning system may present the user with a list or images of products or services 176 that the user could select to be discounted or promoted by a coupon. In an exemplary embodiment, the provisioning system may obtain this list by reference to a database of the merchant's products. Such a list may be provided by an external database. Yet alternatively, or additionally, if merchant 108 has previously used the coupon provisioning system, the list may be a list of products or services that were the subject of coupons previously ordered by the merchant. Other arrangements are possible as well.

As another example, the provisioning system may present the user with a list or images of discounts or other deals 178 that the merchant user could select to be the subject of the coupon. This may be a standard list, may be adapted to correspond with the products or services of the merchant, or may take other forms. Again, this information could be derived from coupons previously sent by the merchant or could be provided in other ways.

The discount or promotion to be provided by a coupon can take any of a variety of forms. As a simple example, the coupon could provide a basic discount off the price of a product or service. As a more complex example, the coupon could provide an incremental or credit value, such as prepaid minutes for use of telecommunications service. In the latter case, the provisioning system would preferably enable the merchant to specify a coupon value, which can be used piecemeal, or over time, by a recipient.

Additionally, the provisioning system may present the user with a list or images (e.g., calendar images) of timeframes or expiration dates 180, which the merchant user could select for the coupon. A coupon expiration date may be an actual date, may be a relative date to be measured from the time of distribution of the coupon, or may take still other forms.

In conjunction with designing the coupon, or as a separate matter, the provisioning system preferably prompts the merchant user to specify a date at which to distribute the coupon. As used herein, the term “date” should be construed liberally to include date, time, day, holiday, or the like, as suitable. The provisioning system may, for instance, present the user with a calendar or clock and allow the user to select a date by pointing and clicking. The system may further allow the user to specify several dates for distribution of the coupon, or a number of times for distribution (i.e., a recurrence) as well as a periodicity or interval between distribution times.

Once the coupon server 102 receives the coupon parameters from merchant 108, the server preferably records the selected coupon parameters in a table of the coupon database, as a record correlated with the merchant for example. This record may be referenced at various times, such as when the coupon system works to send the designated coupon, when a request is made to validate or redeem a distributed coupon, and/or at other times.

C. Selecting Target Recipients

In accordance with an exemplary embodiment of the invention, the target or targets to whom the designated coupon will be sent can be selected based at least in part on location history information maintained in the location log 106. This selection process may be partly or wholly automated. In an exemplary embodiment, generally speaking, the process may involve building a location history profile and then querying the location log to identify subscribers who match the location history profile. A determination may then be made to send the coupon to the identified subscribers.

As with the coupon-provisioning system described above, merchant 108 may communicate with coupon server 102 so that merchant 108 can convey parameters of a location history profile. A profile provisioning system similar to the coupon provisioning system described above can be employed. Similarly, the profile provisioning system can be provided as a web based interface between server 102 and merchant 108 or other entity, or the profile provisioning system can exist locally at merchant 108 or at another entity and merchant 108 can then convey the profile parameters to server 102. Other arrangements are possible as well.

The profile provisioning system can, for example, provide the merchant with a plurality of options that the merchant may use to build a location history profile. Such options may include location-specific information, duration/recurrence information, and subscriber-specific information, for example. Location-specific information can include, for instance, an indication of the location (e.g., one or more specified networks, network addresses (e.g. IP address, telephone number, area code, etc.), geographic addresses, geographic positions, cells, sectors, or the like), location type or size, or a type of facility at the location. Duration/recurrence information can include, for instance, a duration of presence in a location, or a recurrence of presence in a location. Subscriber-specific location can include, for instance, MIN, area code, postal zip code, name, age, race, nationality, or the like. Each of these types of information can take other forms as well.

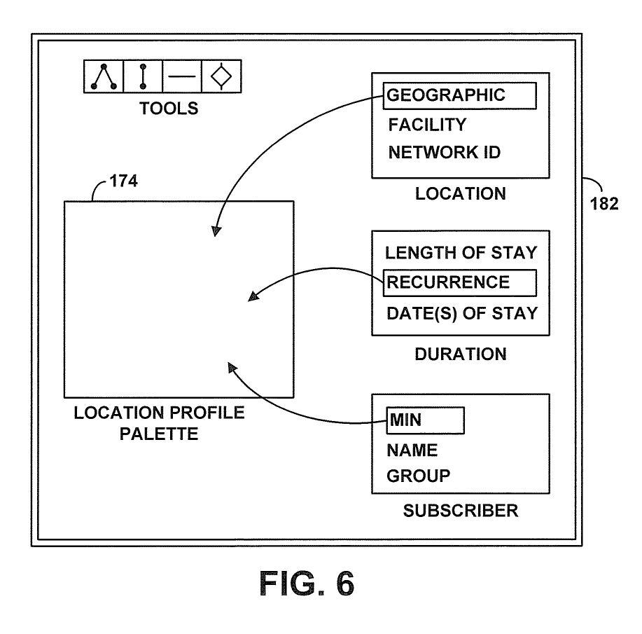

FIG. 6 illustrates an exemplary screen display 182 for a GUI location profile provisioning system. Similar to the coupon provisioning system, the GUI of the profile provisioning system may present various options to the user in a drag and drop form or in any other desired form, allowing the user to effectively build a location database query. Techniques for allowing a user to build such queries in other contexts are well known in the art and are therefore not described here.

Other mechanisms for building a location history profile can be employed in addition or instead. For instance, the coupon provisioning system can employ natural language recognition, so that the merchant user can define the desired location profile in words, whether written or verbal. As an example, a merchant user can convey to the provisioning system the request: “Send the coupon to anyone who has been in any of Chicago, Minneapolis, Boston or Seattle at least 2 times in the last 7 days.” With adequate language recognition, coupon server 102 can understand this request and convert it into a number of parameters defining a corresponding location history profile.

Given the location history profile, the coupon server or another entity may then run a query against the location history information in the location log, to identify any or all hits, i.e., those subscribers whose location history matches the profile. Techniques for querying databases in this way in other contexts are well known in the art and are therefore not described in detail here. Coupon server 102 may directly query location log 106 or may send a query message to another entity, which may then query the location log and return the search results. Alternatively, the merchant itself or another entity may directly or indirectly query the location log to find target recipients that match the specified location history profile. Still other arrangements could be employed as well.

In an exemplary embodiment, the location log 106 returns, and the coupon server 102 thus obtains, a table or list providing information about actual or potential target recipients of the coupon. In this regard, location log 106 preferably returns sufficient information about each target recipient to allow the coupon server or other entity to send the designated coupon to each target. Thus, the type and extent of information provided might vary from target to target, depending on factors such as the type of target (e.g., SMS-capable mobile station, WAP-enabled mobile station, networked computer, e-mail client, etc.) and the type of distribution mechanism(s) that could be used to deliver the coupon to the target recipient. Alternatively, the type and extent of information may be the same for each target or group of targets.

As noted above, in addition to or instead of establishing a location history profile, a merchant can select or otherwise provide the coupon server with a location projection profile, which defines location parameters predicted to occur in the future. A location projection profile may define parameters similar to parameters of a location history profile, such as particular locations for instance, but may also differ in some respects. For instance, a location projection profile may include a parameter defining location during one or more time periods in the future, such as “the next week” or “any Saturday afternoon in the next two months” and so forth. If a location profile provided by the merchant indicates such forward looking events, the coupon server may automatically interpret the location profile to be, at least in part, a location projection profile.

Provided with a location projection profile, the coupon server may query the location log to obtain a sufficient number of historical data points that the coupon server (or other processing entity) could statistically estimate which subscribers match the location projection profile, e.g., based on the location history data, which subscribers are likely to be in the specified location(s) at the specified time(s) or number of times in the future. The coupon server may deem those subscribers to be target subscribers.

Statistical modeling techniques are well known in the art and therefore need not be described here. The coupon server or other entity (such as a location server) could be readily programmed with appropriate modeling logic to facilitate matching a location projection profile based on historical location data. Examples of software for performing such econometric estimates are listed on the World Wide Web at www.oswego.edu/˜economic/econsoftware.htm.

Information for each target subscriber or group can be provided in the form of one or more database records or in any other fashion. For example, if a target subscriber comprises a mobile station, the location query may produce a record that identifies the target subscriber by information such as MIN, owner name and owner billing address. If the target subscriber is a networked computer, the location query could produce a record that identifies the target subscriber by information such as network address (e.g., IP address), e-mail address, user name, and network provider. To the extent the location log does not possess all of the information regarding the target subscriber, some or all of the information could be obtained at or after the query is conducted, by reference to an appropriate mapping database.

In an exemplary embodiment, each target coupon-recipient is a subscriber whose location history has been tracked and logged, so that the coupon can be distributed to the target subscriber at least in part because of the subscriber's particular location history. Alternatively, however, a target recipient could be another entity selected in response to identification of one or more subscribers who match the specified location profile. For example, in a business enterprise, a sales manager may oversee one or more salespeople who may travel throughout several states carrying cellular telephones. A location history query may identify each such salesperson and/or his or her cellular telephone as a match. Rather than (or in addition) to sending the coupon to each salesperson, however, an entity can instead identify the supervisor as the target coupon recipient. As indicated above, the location log or other entity can perform various conversions of data. The conversion of target recipient identities such as is this is an example of one such conversion.

Coupon server 102 preferably stores the results of the location log query in a memory or other storage device for later reference. Coupon server 102 may maintain a database record per coupon recipient for purposes of coupon-tracking. Therefore, upon receipt of the query results, server 102 can establish or modify database records for each target recipient (hereafter a “coupon-distribution record.”) The coupon server may store in each coupon-distribution record any of a variety of information, such as the following, for instance:
(i) Target. One or more fields identifying and pointing to the target recipient, such as MIN, name, e-mail address, network address, street address, service provider, etc.
(ii) Coupon. One or more fields defining aspects of the coupon to be distributed, such as a pointer to a record in the coupon-database that defines the coupon parameters. One such field might include a pointer to a record in the merchant database, defining the merchant that issued the coupon.
(iii) Distribution medium/mode. One or more fields defining one or channels for distribution of the coupon to the target, such as SMS messaging, e-mail messaging, instant messaging, postal delivery, etc.
(iv) Distribution date(s). A distribution date may be established by reference to the coupon field(s), for common distribution dates among all target recipients, or may instead be a target-specific distribution date. One or more such dates, or a periodicity, may be specified for repeated distribution of the coupon.
(v) Expiration date. This date may be established by reference to the coupon field(s), for common expiration dates among all target recipients, or may instead be a target-specific expiration date. The date may be referenced during coupon validation and redemption.
(vi) Coupon-distribution code. This may be a unique code number that will identify the distributed coupon, to avoid duplicate redemption.
(vii) Redemption. This may be a Boolean field or flag that indicates whether the coupon has been redeemed yet, for use in validating or redeeming the coupon.
(viii) Value Remaining on Coupon. This field may be provided for incremental coupons that can be redeemed piecemeal over time. This field may indicate the value that still remains on the coupon. A value of zero would be an indication that the coupon has been fully redeemed. In an alternative embodiment, a user may be allowed to re-charge a coupon, for instance, by contacting a recharging center to purchase or otherwise obtain more value on the coupon.
   The coupon server may store some or all of this or other information in each record upon receipt of the location search query results, and/or the coupon server may store some or all of this information later, such as upon delivery of the coupon to a respective target. Other arrangements are possible as well.

In accordance with an exemplary embodiment of the invention, the coupon server may present the search results to merchant 108 as a list of target subscribers, and merchant 108 may confirm or modify the target list. For instance, via the Internet connection between server 102 and merchant 108, server 102 may provides a web page that lists all of the identified targets and that provides a check box or other selection-mechanism in conjunction with each target or group of targets. A user at merchant 108 may then check any targets to be excluded from receiving the coupon, add additional targets to receive the coupon, or perform other modifications. Merchant 108 may then transmit the modifications to server 102, and server 102 may implement the modifications.

Privacy concerns may exist in this embodiment, however, because the merchant could become privy to the travel patterns and location history of specific subscribers or communication terminals. In an alternative embodiment, therefore, rather than presenting the list of potential targets to the merchant, server 102 may present the merchant with a mere count of target recipients or some other indication of the search results. The coupon server may then request the merchant to approve the distribution of coupons to the target recipients, without disclosing the identities of the recipients to the merchant/user.

As another alternative, the coupon server may be set to generalize the location history profile provided by the merchant before performing the query, if the profile would give rise to information that would be too specific for instance. For instance, if the merchant provides a location profile specifically directed to subscribers who have been at a given street intersection on a given minute of a given day, the coupon server may be programmed to generalize that location profile into one directed to subscribers who have been within 2 blocks of the given intersection at anytime on that given day for instance. This would further help prevent invasion of privacy.

In conjunction with selecting target recipients, or as a separate matter, the coupon server may prompt the merchant/user to select a mode of coupon distribution either per target recipient or per group(s) of target recipients. As will be described more below, example modes of distribution include, without limitation, SMS messaging, e-mail messaging, video insertion into a television signal, telephone call delivery, instant messaging delivery, and postal delivery. The coupon server may present the merchant with a list of options and/or any suitable mechanism for the merchant to select a mode for all target recipients or for specific recipients or groups of recipients.

d. Sending Coupons

Once the coupon server has established the coupon parameters and the target recipients, the coupon server may send the coupon to each target recipient, respectively, at the designated distribution date(s) and/or at another time. Scheduled coupon distribution may be arranged in any suitable fashion. For instance, coupon server 102 can sort the records of the coupon-distribution database in order of distribution date or otherwise monitor the distribution dates and send coupons at their respective distribution dates.

In conjunction with distribution of each coupon, the coupon server may assign a unique coupon-distribution code to each coupon being delivered to a given subscriber or group of subscribers, for use in later validation and redemption. The coupon server may record this coupon-distribution code, as indicated above for instance. The code may take any desired form. For example, the code may comprise a numerical equivalent of a UPC code, incremented successively for each copy of the coupon distributed, i.e., for each successive target recipient.

Coupon distribution in the exemplary embodiment may take any of a variety of forms, some of which are listed above. In general, coupon distribution may comprise sending pertinent coupon parameters to the target recipient. These parameters should preferably define the terms of the coupon, such as the product or service being promoted, the value of the coupon, the expiration date, and the merchant(s) to whom the coupon can be presented for redemption, to the extent appropriate. In an exemplary embodiment, the coupon parameters should include the coupon-distribution number, to facilitate coupon validation and redemption.

The coupon server or other entity preferably formats the coupon parameters in a manner suitable for distribution to each target recipient, respectively, via the designated distribution channel. As an example, if the target recipient is an SMS-entity, such as an SMS-capable cellular telephone, server 102 may prepare an abbreviated form of the coupon for presentation on a small display screen of the telephone. As another example, if the target recipient is a telephone, server 102 may prepare an audio version of the coupon to be played over a telephone connection to the target. As another example, if the target recipient is a cable television subscriber, server 102 may prepare an audio or video version of the coupon for insertion by a video head-end system into a video signal to be delivered to the target. As still another example, if the target recipient is an e-mail client, server 102 may prepare a text version of the coupon listing in detail the coupon parameters, or may prepare a graphical, audio or video rendition of the coupon to be provided as an e-mail attachment. As yet another example, if the target recipient is a person at a postal address, the coupon server may prepare a printed coupon bearing the necessary parameters, for mailing via the postal service to the target. Other examples are possible as well.

The coupon server or other such entity is preferably equipped with all tools necessary to prepare coupons for various distribution channels. For example, for audio or video format, the server may maintain or obtain by reference predefined audio or video segments, which the server can be programmed to combine together to build the audio or video clip representing the coupon parameters.

The coupon server may distribute coupons in a variety of different ways. By way of example, and without limitation, the coupon server may distribute a coupon to SMS-capable mobile station 134 as a conventional SMS message. To do so, the coupon server may send an SMSREQ message to SMSC 18, conveying the coupon as payload. According to industry standards, SMSC would then convey the message to MSC 142, which would in turn convey the message to mobile station 134. Mobile station 134 may then display some or all of the coupon parameters as a conventional SMS message on a screen for viewing by a person.

As another example, the coupon server may distribute a coupon to a WAP-enabled communication terminal such as mobile station 134, via WAP server 138. The coupon server may send a message bearing the coupon parameters to WAP server 138, and WAP server 138 may in turn arrange to forward the message as a WAP display page to mobile station 134. When a person powers on mobile station 134 and opens a data session with WAP server 138, the coupon may thereby be pushed to mobile station 134 for display to the user.

As still another example, the coupon server may distribute a coupon to an e-mail client in the body of an e-mail message or as an attachment to an e-mail message. The coupon would then be delivered to the target recipient like any e-mail message, e.g., according to the SMTP protocol. Similarly, the coupon server may distribute a coupon to an instant messaging client as an instant message via IM server 140.

As yet another example, the coupon server may distribute a coupon to a target recipient via fax transmission. Still further, the coupon server may distribute a coupon to a target recipient via physical postal or courier delivery. The coupon server may, for instance, print out the coupon as a postcard or as an envelope insert, bearing an address of the target recipient. The coupon can then be delivered to the target.

e. Presenting Coupons for Redemption

Upon receipt of a coupon delivered in accordance with an exemplary embodiment, a person associated with the target recipient may then present the coupon to a merchant for redemption. The merchant who receives the coupon for redemption may be the same merchant 108 who ordered the coupon to be delivered in the first place. Alternatively, the receiving-merchant could be an associated entity or another entity that offers the same or another product or service being promoted by the coupon. Other examples are possible as well.

Generally speaking, presentation of a coupon for redemption can involve providing a merchant with sufficient information about the coupon (e.g., coupon parameters) to allow the merchant to redeem the coupon, and preferably to first validate the coupon. Coupon presentation can take any of a variety of forms and can depend on a number of factors such as (i) the mechanism by which the person receives the coupon and (ii) the mechanism by which the merchant is able to receive the coupon for redemption.

As an example, if the coupon is distributed as an SMS-message to a person's SMS-entity (such as a wireless handset), the person can present the SMS-entity itself to the merchant. A cashier at the merchant may then view the SMS message on the display of the SMS-entity and thereby note the coupon-distribution code number associated with the coupon for purposes of validation and redemption of the coupon. Alternatively, provided with an appropriate apparatus, the merchant can mechanically read a display on the SMS-entity. For instance, a suitable scanner could scan the image on the SMS-entity display and thereby identify pertinent coupon parameters.

As another example, if the coupon is distributed to an entity that is capable of transmitting information via a radio frequency or other wireless interface to an appropriate receiver, the coupon can be presented to a merchant by such transmission. In this regard, the telecommunications industry has recently begun to embrace a standard for short-range radio communications, well known in the industry as “Bluetooth.” The details and operation of Bluetooth are known to those skilled in the art and are therefore not described here. If the coupon-receiving entity (such as a mobile station handset) is equipped with a Bluetooth transmitter and the merchant is equipped with a Bluetooth receiver, the coupon can be presented to the merchant selectively or automatically via radio frequency communication from the coupon-receiving entity to the merchant according to the Bluetooth protocol.

Similarly, if the coupon is distributed to an entity that is capable of sending an SMS message to another entity, the coupon could be presented to the merchant by SMS messaging. For instance, if a consumer bears a mobile station that has received a coupon and that is capable of two way SMS messaging (i.e., initiating an SMS message), the consumer may cause the mobile station to send the coupon in an SMS message to an SMS entity associated with the merchant. The merchant's SMS entity could be a mobile station or could, more likely, be a computer terminal that may receive the SMS message as an e-mail message. With present technology, this method of coupon presentation may be slower than others and therefore less desirable, but in the future this method may have significant use as well.

As still another example, if the coupon is distributed in an intangible fashion to a person, such as in a video or audio signal, or even if the coupon is distributed in a tangible form, the person may obtain the coupon-distribution code and/or other identifying parameters from the coupon and may verbally convey those parameters to the merchant. As still another example, if the coupon was distributed in paper format to a person, the person could present the paper-form coupon the merchant as is conventional.

As yet another example, it is possible that the distributed coupon relates to purchase or use of services within network 100. For instance, the coupon may provide a discount to be applied to purchases made at e-commerce web sites on the Internet, such as a coupon allowing the recipient to freely download a certain part of a software program. In that event, the recipient of the coupon may present the coupon for redemption by transmitting one or more coupon parameters to an applicable merchant web site.

As still another example, the coupon may provide the recipient with a quantity (e.g., a number of minutes) of prepaid telecommunications service. In that event, the coupon-distribution number might be a code number similar to a pre-paid calling card number. The recipient may then, for instance, submit the coupon for redemption in the same way that prepaid calling-card numbers are conventionally entered, such as by DTMF entry or the like.

f. Validating/Redeeming Coupons

In an exemplary embodiment, the merchant who receives the coupon is or can be coupled by a suitable communications link to the coupon server 102, for use in validating and/or redeeming the coupon. If the receiving-merchant is merchant 108, this communications link can be IP network 104 as shown in FIG. 3. Other examples are possible as well.

When the merchant receives the coupon, the merchant preferably communicates with the coupon server 102 to validate and redeem the coupon. Preferably, the merchant then provides the server with the coupon-distribution code of the coupon. Upon receipt of the coupon-distribution code, the server queries the coupon database to find the database record associated with the coupon-distribution code. The server then examines the redemption flag associated with the coupon record to determine whether the coupon has yet been redeemed (and/or whether value still remains on the coupon, if appropriate), and the server examines the expiration date associated with the coupon record to determine if the coupon is still valid. If the redemption flag is set or the expiration date has passed, for instance, the server may send a negative response message to the merchant, and the merchant may decline to accept the coupon. If, however, the redemption flag is not set and the expiration date has not yet passed, the server may set the redemption flag (or decrement the coupon value, if appropriate) and send a positive message to the merchant acknowledging redemption (or partial redemption) of the coupon. The merchant may then apply the coupon accordingly.

In the event the coupon that the consumer presents to the merchant does not explicitly identify the goods or services, the discount, or other parameters that the merchant might need to apply the coupon to a purchase, server 102 can provide that information to the merchant. For instance, if the consumer presents the merchant with only the coupon-distribution number, and the merchant conveys that number to server 102, server 102 may responsively send a message to the merchant identifying the pertinent coupon parameters (such as the product or service discounted and the amount of discount) for reference and use by the merchant.

Coupons can be managed, accounted and tracked by the merchant, by the coupon server, and/or other entities. For instance, the coupon server may maintain records of coupons redeemed and may periodically send reports of coupon redemption to the merchants who ordered the coupons and/or to the merchants who submitted the coupons for redemption. The coupon server can also include in such records indications of when and where the coupons were redeemed, to facilitate tracking of coupon use.

4. Conclusion

An exemplary embodiment of the present invention has been illustrated and described. It will be understood, however, that changes and modifications may be made to the invention as described without deviating from the spirit and scope of the invention, as defined by the following claims.

We claim:

1. A method of coupon distribution and use comprising, in combination:
receiving into a consumer's subscriber device a coupon transmitted to the subscriber device from a coupon server, the coupon defining coupon parameters; and
presenting the subscriber device to a merchant so as to convey from the subscriber device to the merchant at least one of the coupon parameters for use by the merchant in a sales transaction between the consumer and the merchant.

2. The method of claim 1, wherein presenting the subscriber device to the merchant comprises the consumer presenting the subscriber device to the merchant when the consumer is physically present at the merchant.

3. The method of claim 1, wherein the coupon parameters comprise at least one parameter selected from the group consisting of a product or service being promoted, a value of the coupon, an expiration date of the coupon, and at least one merchant to whom the coupon is presentable for redemption.

4. The method of claim 1, wherein the coupon parameters comprise a coupon-distribution number usable by the merchant to facilitate redemption of the coupon.

5. The method of claim 1, wherein receiving the coupon into the subscriber device comprises receiving the coupon via short messaging service (SMS) into the subscriber device.

6. The method of claim 1, wherein receiving the coupon into the subscriber device comprises receiving the coupon via WAP push delivery into the subscriber device.

6. The method of claim 1, further comprising displaying the at least one coupon parameter on a display of the subscriber device,
wherein presenting the subscriber device to the merchant so as to convey the at least one coupon parameter to the merchant comprises presenting to the merchant the subscriber device display bearing the displayed at least one coupon parameter.

7. The method of claim 6, further comprising the merchant mechanically reading the subscriber device display so as to receive the at least one displayed coupon parameter.

8. The method of claim 7, wherein mechanically reading comprises scanning.

9. The method of claim 1, wherein presenting the subscriber device to the merchant so as to convey the at least one coupon parameter to the merchant comprises presenting the subscriber device to the merchant so as to convey the at least one coupon parameter via a radio frequency interface from the subscriber device to the merchant.

10. The method of claim 1, wherein presenting the subscriber device to the merchant so as to convey the at least one coupon parameter to the merchant comprises presenting the subscriber device to the merchant so as to convey the at least one coupon parameter via an infrared interface from the subscriber device to the merchant.

11. The method of claim 1, wherein presenting the subscriber device to the merchant so as to convey the at least one coupon parameter to the merchant comprises inserting the subscriber device into a docking station provided by the merchant, to facilitate conveyance of the at least one coupon parameter from the subscriber device to the merchant.

12. The method of claim 1, wherein presenting the subscriber device to the merchant comprises presenting the subscriber device to a person at the merchant.

13. The method of claim 1, further comprising:
signaling from the merchant via a network to a coupon server to validate and redeem the coupon.

14. The method of claim 13, further comprising:
receiving at the merchant from the coupon server at least one additional coupon parameter defining an aspect of the coupon.

15. A method of coupon distribution and use comprising, in combination:
sending to a mobile station an SMS message carrying a number of coupon parameters cooperatively defining a coupon;
receiving the SMS message at the mobile station, and displaying the coupon parameters on a display of the mobile station; and
presenting the mobile station display to a merchant so as to convey at least one of the coupon parameters to the merchant, whereby the merchant receives the at least one coupon parameter from the display of the mobile station and uses the at least one coupon parameter in a sales transaction.

16. The method of claim 15, further comprising:
the merchant mechanically reading the at least one coupon parameter from display of the mobile station.

17. The method of claim 16, further comprising:
the merchant signaling with a coupon server to validate and redeem the coupon.

18. A coupon delivery and use method comprising, in combination:
sending a coupon to a mobile station, the coupon defining coupon parameters;
displaying the coupon parameters at the mobile station;
presenting the mobile station with displayed coupon parameters to a merchant; and
the merchant receiving at least a portion of the displayed coupon parameters from the display of the mobile station and sending the at least a portion of the coupon parameters to a coupon server, whereby the coupon server may validate the coupon.

19. A coupon delivery and use method comprising, in combination:
receiving into a merchant's system, via a radio frequency interface between the merchant's system and a consumer's mobile station, a coupon that was transmitted to and received by the mobile station; and
signaling from the merchant system to a coupon server to validate the coupon received by the merchant's system, and to redeem the coupon for use in a sales transaction between the consumer and the merchant.

20. The coupon delivery and use method of claim 19, wherein the coupon comprises a plurality of coupon parameters including at least one parameter selected from the group consisting of a product or service being promoted, a value of the coupon, an expiration date of the coupon, and at least one merchant to whom the coupon is presentable for redemption.
